(19) United States
(12) Patent Application Publication
(10) Pub. No.: US 2006/0266684 A1
(43) Pub. Date: Nov. 30, 2006

(54) Chromatography column with movable adapter

(76) Inventor: Ulf Pichl, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/558,091

(22) PCT Filed: May 21, 2004
(86) PCT No.: PCT/EP04/05524

§ 371 Date: Jul. 27, 2006

(30) Foreign Application Priority Data
May 23, 2003 (GB) 03118544

(51) Int. Cl. B01D 15/08

(52) U.S. Cl. 210/198.2

(57) ABSTRACT

In order to reduce the space required above a chromatography column provided with a movable adapter (17) connected to a duct (33) able to slide though a duct receiving opening (25′) in an end plate (7) of the column, the duct (33) is made flexible.

### FIELD OF THE INVENTION

The present invention relates to a column construction which includes a movable adaptor that can be used to deliver liquid to or to lead liquid away from a liquid permeable bed inside the column. The expression “movable” means that the adaptor can be moved in the direction of flow applied during an adsorption/desorption/washing process.

### DESCRIPTION OF THE BACKGROUND ART

Movable adapters have been used in chromatography in conjunction with matrices which are packed conventionally in columns and also in expanded bed columns. The controlled movement of the adapters has been achieved by applying a controllable force to the adaptor, for example, by applying a hydraulic/pneumatic pressure to the sealed space between the adaptor and an upper end-piece of the column. This requires the use of a hollow duct which extends up from the adaptor through the column end-piece, in order to act as a conduit for liquids flowing to or from the adapter. One such column is shown in U.S. Pat. No. 6,280,616.

The main drawbacks of this arrangement is that because the duct attached to the movable adapters is almost as long as the column, the height of the ceiling above a column must be in the order of twice the height of the column in order to accommodate the length of the duct which protrudes from the top of the column when the adapter is at its highest position.

The present invention provides improvements with regard to the drawback of the prior art.

An example of a column in accordance with the present invention is shown in the appended drawings. The drawings are not to scale.

### BRIEF DESCRIPTION OF THE DRAWINGS

FIG. 1a) is a schematic lateral view of a prior art chromatography column with a movable adapter in its lowest position;

FIG. 1b) is a schematic lateral view of the same column with the movable adapter in its highest position:

FIG. 2a) is a schematic lateral view of a first embodiment of a chromatography column in accordance with the present invention with a movable adapter at its lowest position;

FIG. 2b) is a schematic lateral view of the first embodiment of a column in accordance with the present invention with the movable adapter in its highest position;

FIG. 3 is a schematic lateral view of another embodiment of a column in accordance with the present invention;

FIG. 4 is a schematic lateral view of a further embodiment of a column in accordance with the present invention; and,

FIG. 5 is a schematic lateral view of an additional further embodiment of a column in accordance with the present invention.

Details of the embodiments which have the same function have been identified with the same reference numerals in the figures, unless otherwise stated.

### DESCRIPTION OF THE INVENTION

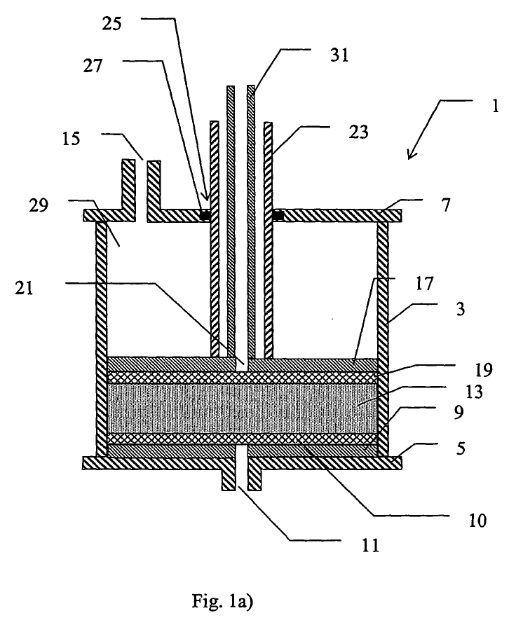

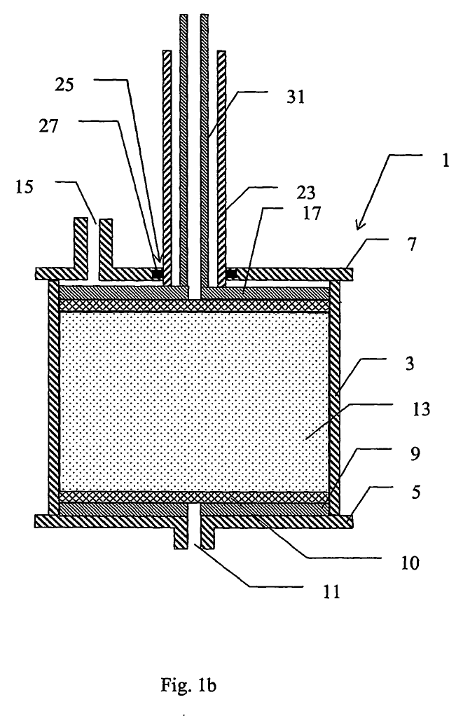

FIG. 1 shows a chromatography column 1 which comprises a column tube 3 which connects a first end plate 5 positioned at the lower end of the column tube 3 with a second end plate 7 positioned at the top end of the column tube 3. First end plate 5 is provided with a bottom adaptor 9 and has a through hole 11 through which liquid can be delivered to/led away from the bottom adapter 9. Bottom adapter 9 is provided with a distribution system 10 for the distribution/collection of liquid flow towards/from the lower part of a column bed 13. Second end plate 7 is provided with an inlet/outlet for pressurised fluid 15 which is connectable to a source (not shown) of pressurised fluid such as pressurised hydraulic fluid or pressurised gas. A movable adaptor 17 is positioned in the column above the column bed 13 and below the second end plate 7. Movable adapter 17 seals against the inside wall of the column tube 3. Movable adapter 17 may be provided with a distribution system 19 for the distribution/collection of liquid flow towards/from the upper part of the column bed 13. A hole 21 extends through the movable adapter 17 from the distribution system 19 to the face of the movable adapter facing the second end plate 7. A hollow rigid duct 23 extends parallel to the longitudinal axis of the column from the face of the movable adapter facing the second end plate 7 through a duct receiving opening 25 in the second end plate 7. Sealing means 27 are provided between duct 23 and duct receiving opening 25 to prevent leakage of fluids out of the space 29 between the movable adapter 17 and the second end plate 7. Hollow rigid duct 23 encloses a conduit 31 which is connected to hole 21 and which can be used to deliver fluid to, or lead fluid away from, the movable adapter 17.

In FIG. 1a) the movable adapter 17 has been pushed to a position in the lower region of the column 1 by pressurised fluid applied to the sealed space between movable adapter 17 and second end plate 7. Only a small length of hollow rigid duct extends above second end plate 7.

In FIG. 1b) the movable adapter 17 has been moved to a position in the upper region of the column 1 by reducing the pressure of the pressurised fluid in the sealed space between movable adapter 17 and second end plate 7 and/or increasing the pressure of the fluid in the column bed and/or by pulling on hollow rigid duct 23. In this position a large length of hollow rigid duct 23 extends above second end plate 7 and any building in which the column is mounted needs to have a ceiling high enough to accommodate this large length.

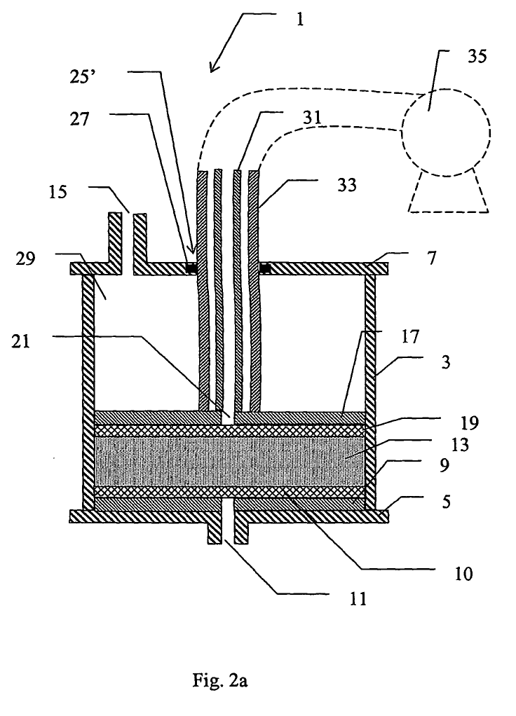

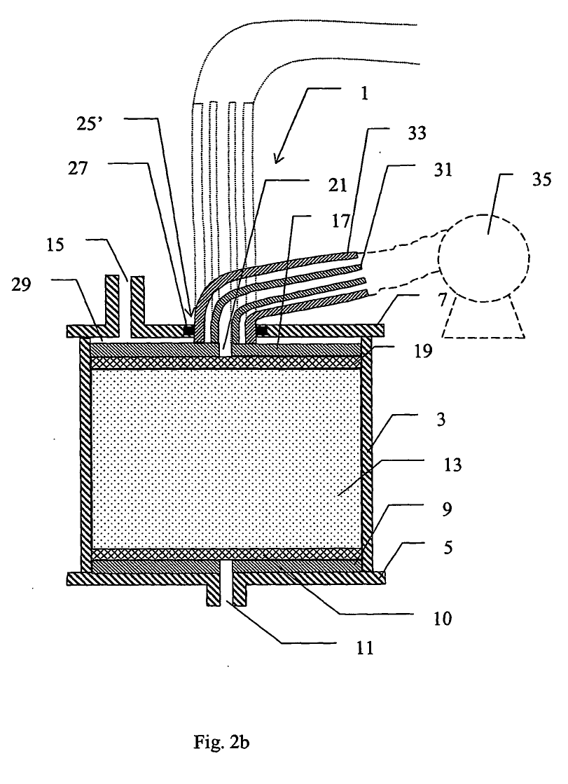

FIGS. 2a and 2b show schematically a first embodiment of a chromatography column provided with a movable adapter in accordance with the present invention. In this column the hollow rigid duct 23 known from the prior art is replaced by a flexible duct 33. Flexible duct 33 is slidable though a duct receiving opening 25′ in second end plate 7. Flexible duct 33 is preferably made from smooth walled tubing which is stiff enough to seal against sealing means 27 (which are provided in the duct receiving opening 25 in second end plate 7) when it slides past said sealing means 27. At the same time flexible duct 33 should preferably be flexible enough so that instead of projecting vertically out of duct receiving opening 25 (i.e. parallel with the longitudinal axis of the column) it can be bent to lie substantially perpendicular to the longitudinal axis of the column, thereby reducing the amount of free space needed above the column to accommodate the duct. To ease handling, flexible duct 33 may be flexible enough to be wound onto duct storage means—such as a reel 35 or drum positioned outside the column—as the movable adapter 17 is raised towards the second end plate 7. Removing the duct from the column as the movable adapter 17 rises prevents the duct 33 from collecting inside the column between the movable adapter 17 and the second end plate 7 where it could be damaged or where it could prevent the movable adapter 17 from rising all the way to the second end plate 7. Conduit 31 is also made flexible enough to follow the bending of flexible duct 33. FIG. 2a) shows the column when the movable adapter is at a position in the lower region of the column 1. FIG. 2b) shows the column when the movable adapter is at a position in the upper region of the column 1. Instead of projecting vertically, duct 33 and conduit 31 are bend sideways after exiting the duct receiving opening 27′. Dotted lines show how much the flexible duct 33 and conduit 31 would extend above the column if they were rigid and projected parallel to the longitudinal axis of the column tube instead of being flexible and able to be bent sideways.

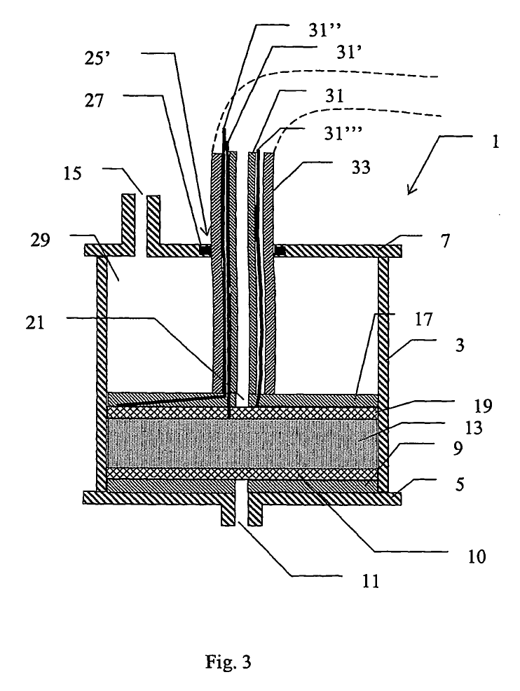

FIG. 3 shows a second embodiment of the present invention. In this embodiment, duct 33 surrounds a plurality of conduits 31, 31′, 31″, 31′″ which are connected to different parts of movable adapter 17. Conduit supplies fluid to the movable adapter as shown in the previous embodiments. The conduits 31′-31′″ (shown by solid lines) may be used for different functions such as supplying fluids to the interior of the column without passing through the distribution system 19 (see conduit 31′), or cleaning the distribution system e.g. by supplying fluid to the distribution system with conduit 31″ while removing fluid from another part of the distribution system with a different conduit 31′″, etc.

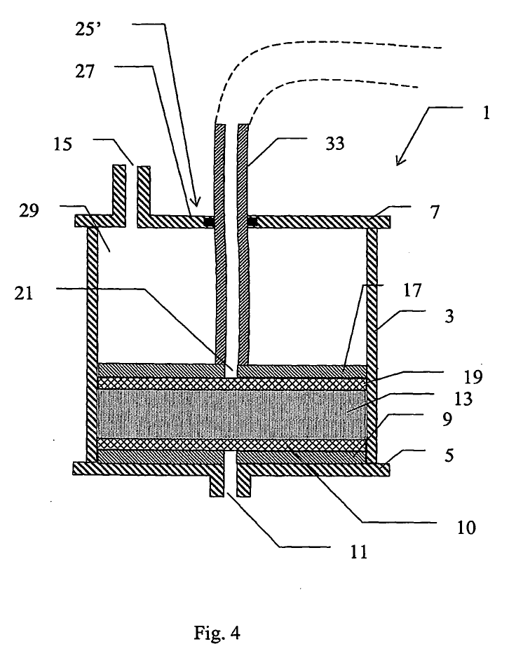

FIG. 4 shows another embodiment of the present invention. In this embodiment, duct 33 acts as a conduit connectable to hole 21 in movable adapter 17.

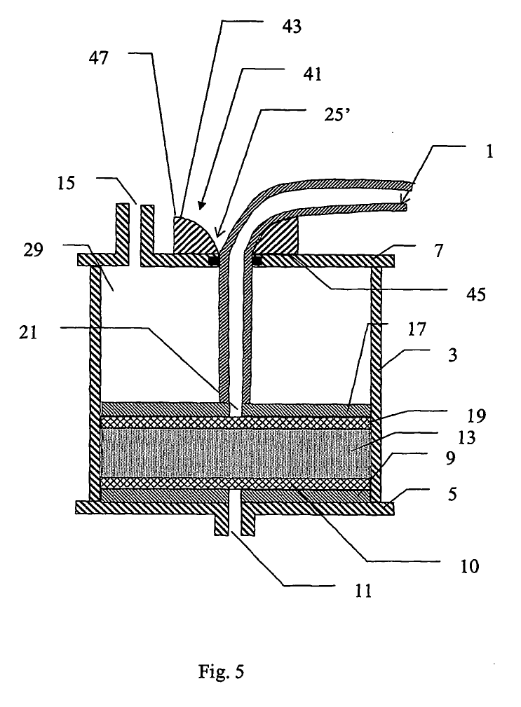

FIG. 5 show an additional further embodiment of a column in accordance with the present invention. This embodiment is similar to the embodiment shown in FIG. 4, with the difference that duct receiving opening 25′ is surrounded by a duct anti-kink device such as duct anti-kink collar 41 positioned outside the column. Collar 41 is an annular collar in which the inner surface 43 facing toward the centre of the collar is radiused such that the diameter of the central opening in the collar at the side face 45 of the collar facing towards the column is substantially equal to the diameter of the duct 33, while the diameter of the central opening in the collar at the side face 47 of the collar 41 facing away the column is greater than the diameter of the duct 33. This collar 41 ensures that the duct 33 is able to be bent smoothly where it exits the end plate 7, thus avoiding a kink in the duct 33 there if the duct is bent e.g. such that it is perpendicular to the longitudinal axis of the column.

Various other shapes of anti-kink devices are conceivable, for example an anti-kink collar may have a round, oval, triangular or other cross-sectional shape instead of the quadrant-shaped cross-section shown in FIG. 5. Alternatively an anti-kink device may be in the form of a fence surrounding and, preferably, spaced away from the duct receiving opening. The height of the fence and its distance from the duct receiving opening may be adapted to smooth the path of the duct and avoid kinking when the duct is bent e.g. such that it is perpendicular to the longitudinal axis of the column.

Such anti-kink collars are optionally usable on all embodiments of the present invention.

As the duct 33 is flexible, it provides less support to the movable adapter 17 and distribution system 19 (if fitted) than a solid support would. This means that if the aspect ratio (height to width ratio) of the movable adapter and distribution system (if fitted) is too low then there is a risk of the movable adapter and distribution system tilting in the column. This is undesirable as they may allow fluid to leak past them and/or may be come jammed in the column. In order to prevent this, in an embodiment of a column in accordance with the present invention the aspect ratio of a movable adapter or a movable adapter and attached distribution system assembly is preferably equal to or greater than 5% (i.e. the maximum height of the movable adapter or assembly is equal to or greater than 5% of the maximum width of the movable adapter or assembly). More preferably the aspect ration is equal to or greater than 10% and even more preferably the aspect ration is equal to or greater than 20%. In some cases, for example in columns where the movable adapter or assembly is not very rigid, higher aspect ratios may be needed, for example aspect ratios equal to or greater than 50%, or equal to or greater than 100%.

Possible suitable materials for the flexible ducts and conduits are tubes made of plastic, composite materials and metals. The ducts and conduits may be reinforced, for example with helical or round reinforcing strips or wires in order to ensure a good seal against the duct receiving opening sealing means, and may be coated with low-friction coating to facilitate sliding through the sealing means in the duct receiving opening. Said sealing means can be any sealing means which prevent leakage of pressurised fluid though the duct receiving opening while at the same time allow the duct to slide though the sealing means.

While the invention has been illustrated by examples showing columns using packed beds, it is also applicable to columns using expanded beds.

The above mentioned embodiments are intended to illustrate the present invention and are not intended to limit the scope of protection claimed by the following claims.

1. A chromatography column comprising a first end plate (5) and a second end plate (7) separated by a column tube (3), wherein said column tube contains a movable adapter (17) connected to a duct (33) able to slide though a duct receiving opening (25) passing through said second end plate (7) and further wherein said duct (33) is flexible.

2. The chromatography column of claim 1, wherein said duct receiving opening (25) is provided with sealing means (27) for slidably sealing against said duct (33).

3. The chromatography column of claim 1, wherein said duct (33) contains at least one flexible conduit (31-31′″) connectable to said movable adapter.

4. The chromatography column of claim 1, wherein said column is provided with duct storage means (35) positioned outside said column.

5. The chromatography column of claim 4, wherein said duct storage means (35) is a reel or drum.

6. The chromatography column of claim 1, further comprising an anti-kink device for said flexible duct (33).

7. The chromatography device of claim 1, wherein said movable adapter, or movable adapter and a fitted distribution system, has an aspect ratio equal or greater than 5%.

8. The chromatography device of claim 7, wherein said movable adapter, or movable adapter and a fitted distribution system, has an aspect ratio equal or greater than 10%.

9. The chromatography device of claim 7, wherein said movable adapter, or movable adapter and a fitted distribution system, has an aspect ratio equal or greater than 20%.
